(19) United States
(12) Patent Application Publication
(10) Pub. No.: US 2012/0164380 A1
(43) Pub. Date: Jun. 28, 2012

(54) TEXTURED STRUCTURE, TEXTURING METHOD, AND ELECTRONIC DEVICE WITH TEXTURED STRUCTURE

(75) Inventors: YONG-JUN YU, Shenzhen City (CN); NA WANG, Shenzhen City (CN); BAO-GANG ZHAO, Shenzhen City (CN); HE-LI WANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/166,869

(22) Filed: Jun. 23, 2011

(30) Foreign Application Priority Data
Dec. 27, 2010 (CN) 201010607431.6

(51) Int. Cl. B32B 3/00; B23P 17/04

(52) U.S. Cl. 428/141; 29/592

(57) ABSTRACT

A textured structure includes a main body, a first textured surface and a second portion arranged on the main body. At least a part of the second textured portion is surrounded by the first textured surface, and the height H from the first textured surface to the main body is greater than the height L from the second textured surface to the main body. A textured method and an electronic device with the textured structure are also provided.

### BACKGROUND

1. Technical Field

The present disclosure relates to textured structure, texturing method, and electronic devices with textured structures.

2. Description of Related Art

Exterior surface of the housing of electronic devices usually define a textured structure for aesthetics and sometimes for strength. Often more than one pattern of textured structure are implemented. However, different textured structures are always formed at the same time by molding, and anomalous features, such as burrs and bleeding lines, are easily formed.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the three views.

FIG. 1 is a perspective view of an electronic device with a textured structure in accordance with an embodiment.

FIG. 2 is a partial cross-sectional view taken along line II-II of FIG. 1.

FIG. 3 is a flow chart of a texture method in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

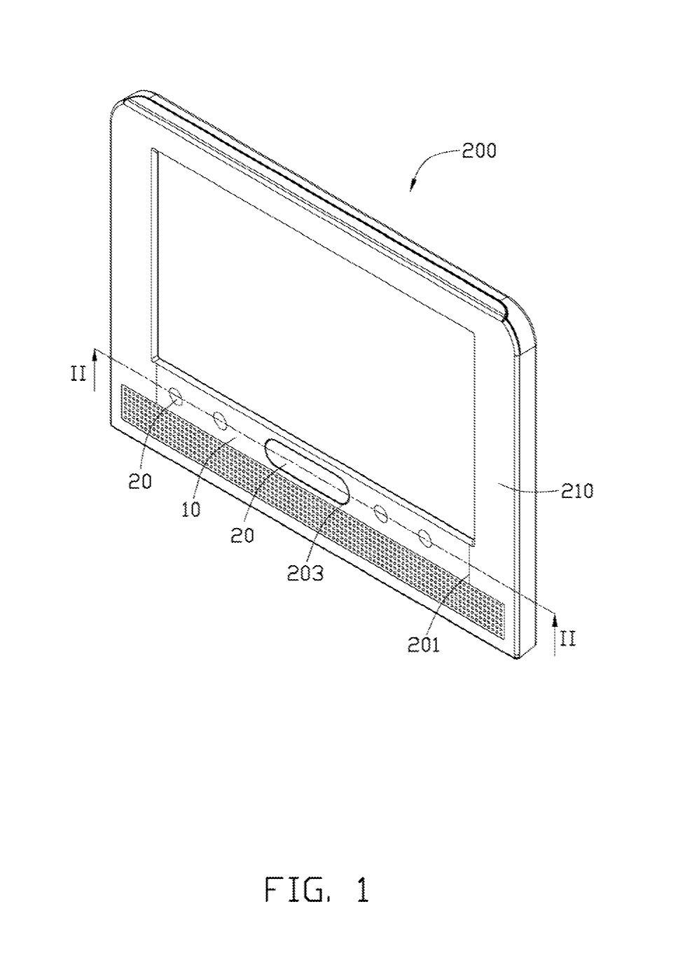

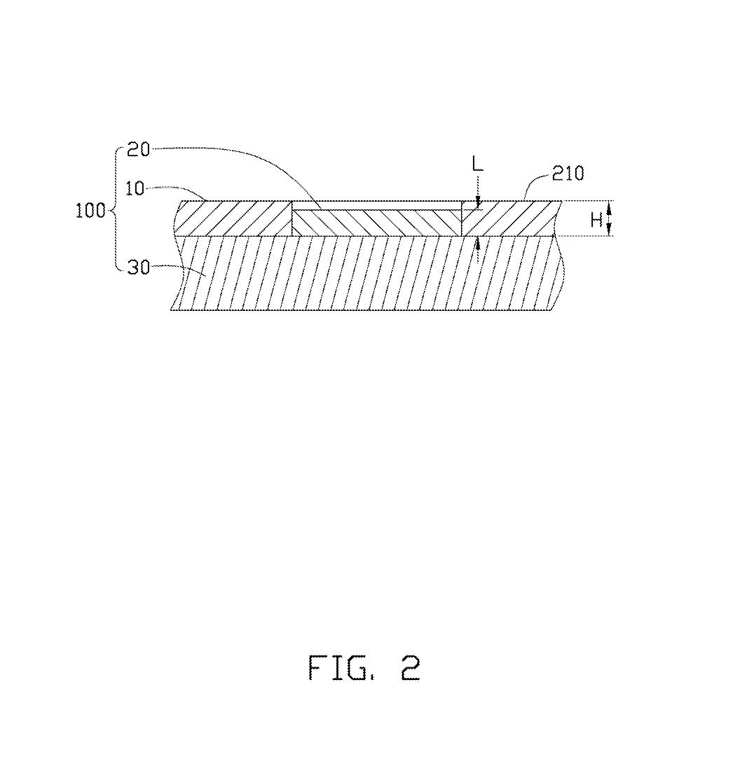

Referring to FIGS. 1 and 2, an electronic device 200 with a textured structure 100 in accordance with an embodiment is shown. The textured structure 100 includes a main body 30, a first textured surface 10 and a second textured surface 20 disposed on the main body 30. In some embodiments, the main body 30 may be a front panel of the electronic device 200, such as a DVD player.

The first textured surface 10 is different from the second textured surface 20. The size of the first textured surface 10 is larger than that of the second textured surface 20. The height H from the first textured surface 10 to the main body 30 is greater than the height L from the second textured surface 20 to the main body 30 (namely, the recessed height of the first textured surface 10 from the front surface 210 is less than that of the second textured surface 20). The difference between the height H and the height L is between 0 and 0.1 (mm). In the embodiment, the first textured surface 10 recesses to define the second textured surface 20, the first textured surface 10 surrounds the second textured surface 20, and the difference between the height H and the height L is 0.05 (mm). In other embodiments, a part of the second textured surface 20 is recessed from and is surrounded by the first textured surface 10. As the second textured surface 20 is recessed from the first textured surface 10, the height H of the first textured surface 10 relative to the main body 30 is greater than the height L of the second textured surface 20 relative to the main body 30. Thus, when the textured structure 100 is partially textured to define the first and second textured surfaces 10, 20, anomalous features, such as burrs and bleeding lines are avoided.

Referring again to FIG. 1, for better understanding of the textured structure 100, the electronic device 200 having a control panel 201 including a plurality of keys 203 is taken as an example. First, the front surface 210 of the electronic device 100 is partially textured to define the first textured surface 10, the first textured surface 10 functions as the control panel 201 of the electronic device 200. Then, the first textured surface 10 is partially textured to define a plurality of second textured surfaces 20, the second textured surfaces 20 functions as touch keys 203 of the electronic device 200, in the embodiment, the first textured surface 10 is recessed to define the second textured surfaces 20. The control panel 201 and the keys 203 are different textured structures, thus, the keys 203 disposed in the control panel 201 are distinct.

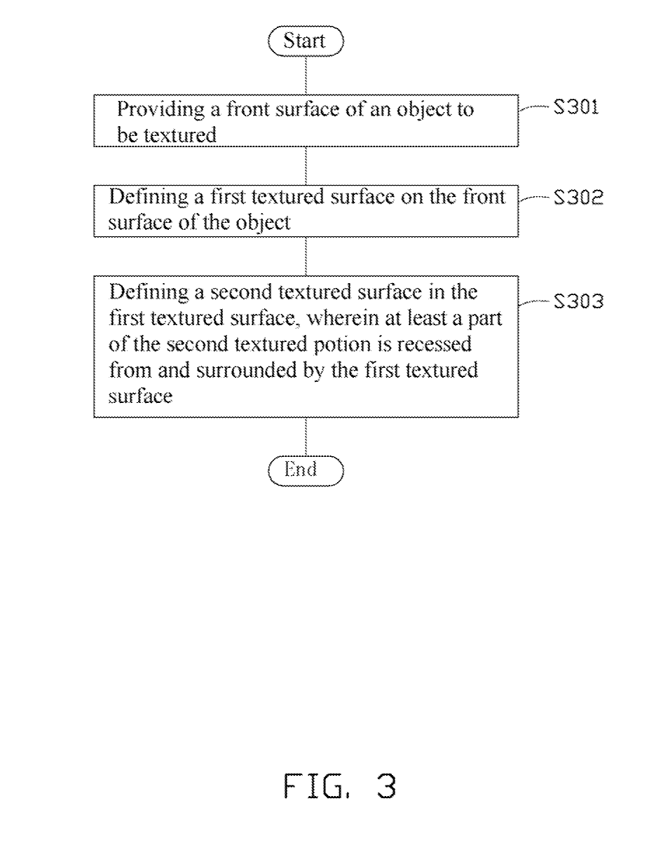

Referring to FIG. 3, a flow chart of a texturing method in accordance with an embodiment is shown. The texturing method is used for defining a textured structure 100 in a surface of an object, such as an electronic device 200. The texturing method includes following steps:

In step S301, the front surface 210 of the electronic device 100 is provided to be textured.

In step S302, the front surface 210 of the electronic device 100 is partially textured to define the first textured surface 10.

In step S303, the first textured surface 10 is further partially textured to define the second textured surface 20, whereby the textured structure 100 is formed. The second textured surface 20 is surrounded or is partially surrounded by the first textured surface 10, the size of the second textured surface 20 is less than that of the first textured surface 10, and the recessed depth of the second textured surface is greater than that of the first textured surface 10.

By virtue of the textured structure 100 and the texturing method, when the electronic device 200 is partially textured to define the textured portions, anomalous features, such as burrs and bleeding lines, can be avoided or minimized.

It is to be understood, even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A textured structure, comprising:
a main body;
a first textured surface arranged on the main body; and
a second textured surface arranged on the main body;
wherein at least a part of the second textured potion is surrounded by the first textured surface, and the height H from the first textured surface to the main body is greater than the height L from the second textured surface to the main body.

2. The textured structure of claim 1, wherein the size of the first textured surface is larger than that of the second textured structure.

3. The textured structure of claim 2, wherein the first textured surface recesses to define the second textured surface.

4. The textured structure of claim 1, wherein the difference between the height H and the height L is between 0 and 0.1 (mm).

5. The textured structure of claim 1, wherein the difference between the height H and the height L is 0.05 (mm).

6. An electronic device, comprising:
a surface defining a textured structure, the textured structure comprising a main body, a first textured structure and a second textured structure, the first textured structure and the second textured structure arranged at on the main body;
wherein at least a part of the second textured potion is surrounded by the first textured surface, and the height H from the first textured surface to the main body is greater than the height L from the second textured surface to the main body.

7. The textured structure of claim 6, wherein the size of the first textured surface is larger than that of the scone textured structure.

8. The textured structure of claim 7, wherein the surface of the electronic device is partially textured to define the first textured surface, and the first textured surface further recesses to define the second textured surface.

9. The textured structure of claim 6, wherein the difference between the height H and the height L is between 0 and 0.1 (mm).

10. The textured structure of claim 6, wherein the difference between the height H and the height L is 0.05 (mm).

11. A texturing method for defining a textured structure, comprising:
providing a surface to be textured;
defining a first textured surface in the surface; and
defining a second textured surface in the first textured structure, wherein at least a part of the second textured potion is recessed from and surrounded by the first textured surface.

12. The texturing method of claim 11, wherein the textured structure comprising a main body, the first textured structure and the second textured structure are arranged at the main body.

13. The texturing method of claim 12, wherein the size of the first textured surface is larger than that of the scone textured structure.

14. The texturing method of claim 13, wherein the height H of the first textured surface relative to the main body is greater than the height L of the second textured surface relative to the main body.

15. The texturing method of claim 14, wherein the difference between the height H and the height L is between 0 and 0.1 (mm).

16. The texturing method of claim 11, wherein the difference between the height H and the height L is 0.05 (mm).
